(19) United States
(12) Patent Application Publication
(10) Pub. No.: US 2006/0045340 A1
(43) Pub. Date: Mar. 2, 2006

(54) Character recognition apparatus and character recognition method

(75) Inventors: Masayoshi Sakakibara, Ebina-shi (JP); Kotaro Nakamura, Minato-ku (JP); Masakazu Tateno, Ashigarakami-gun (JP); Kei Tanaka, Ashigarakami-gun (JP); Teruka Saito, Ashigarakami-gun (JP); Toshiya Koyama, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/080,489

(22) Filed: Mar. 16, 2005

(30) Foreign Application Priority Data
Aug. 25, 2004 (JP) 2004-245311

(51) Int. Cl. G06K 9/18

(52) U.S. Cl. 382/182

(57) ABSTRACT

The present invention provides a character recognition apparatus including: plural dictionary databases that contain terms or characters classified into respective fields; a determination unit that determines which field the contents of a document shown by document image data belong to; a selection unit that selects a dictionary database pertaining to the field determined by the determination unit from among the plural dictionary databases; a recognition unit that recognizes a term or a character written in the document shown by the document image data by using the terms or characters stored in the selected dictionary database as candidates; and an output unit that outputs the result of recognition by the recognition unit.

This application claims priority under 35 U.S.C. §119 of Japanese Patent Application No. 2004-245311 filed on Aug. 25, 2004, the entire content of which is hereby incorporated by reference.

### BACKGROUND OF THE INVENTION

1. Field of the Invention

The invention relates to a technology for recognizing characters read from a document.

2. Description of the Related Art

In a character recognition technology called OCR (Optical Character Reader), candidates for a number of characters or terms are registered into dictionary databases in advance. The characters (terms) registered in the dictionary databases and characters (terms) optically read from a document are compared to recognize the characters (terms) in the document. The recognition accuracy thus depends largely on whether the dictionary databases contain appropriate characters or terms.

It is known to provide dictionary databases, which are prepared in advance, for plural languages such as Japanese and English. Then, words composed of characters obtained through a document recognition process are recognized, and one of the foregoing dictionary databases is selected. If the recognized words are registered in the selected dictionary by a ratio (relevance ratio) of or above a predetermined value, the recognition process is continued by using the dictionary. If the ratio falls below the predetermined value, the foregoing processing is performed again by using another dictionary database. This technique requires, however, that characters be recognized accurately and words be recognized appropriately in the stage prior to the dictionary inquiry. In addition, this technique is intended for language selection, and thus will not contribute to an improvement in the recognition accuracy of, e.g., a Japanese document itself.

It is known to provide another technique that a series of character strings read optically is separated in units of several characters to extract term candidates. Then, it is determined whether the linkage of characters in each of the term candidates matches with one of those registered in a dictionary database. If no match, term candidates are extracted in a different way. This technique requires, however, that all the linkages of characters for constituting term candidates be prepared in advance. The database thus becomes extremely large in capacity. Moreover, searching for all the linkages character by character complicates the processing greatly, requiring a considerable amount of process time.

### SUMMARY OF THE INVENTION

The present invention has been made in view of the above circumstances, and provides a new mechanism for recognizing characters written in a document with a higher degree of accuracy.

To address the foregoing problems, the present invention provides a character recognition apparatus including: plural dictionary database that contain terms or characters classified into respective fields; a determination unit that determines which field the contents of a document shown by document image data belong to; a selection unit that selects a dictionary database pertaining to the field determined by the determination unit from among the plural dictionary databases; a recognition unit that recognizes a term or a character written in the document shown by the document image data by using the terms or characters stored in the selected dictionary database as candidates; and an output unit that outputs the result of recognition by the recognition unit. According to this character recognition apparatus, the field to which the contents of a document belong is determined before a field specific term dictionary database appropriate for that field is selected and used for character recognition. An improvement is thus expected of the recognition accuracy.

### BRIEF DESCRIPTION OF THE DRAWINGS

Embodiments of the present invention will be described in detail based on the following figures, wherein:

FIG. 1 is a block diagram showing the configuration of a character recognition apparatus according to a first embodiment;

FIG. 2 is a flowchart showing the operation of the character recognition apparatus;

FIG. 3 is a flowchart showing the operation of the character recognition apparatus;

FIG. 4 is a block diagram showing the configuration of a character recognition apparatus according to a second embodiment;

FIG. 5A to 5E are diagrams conceptually showing the contents to be stored into a section format database;

FIG. 6 is a flowchart showing the operation of the character recognition apparatus; and

FIG. 7 is a flowchart showing the operation of the character recognition apparatus.

### DETAILED DESCRIPTION OF THE INVENTION

Now, description will be given of embodiments of the present invention.

### (1) First Embodiment

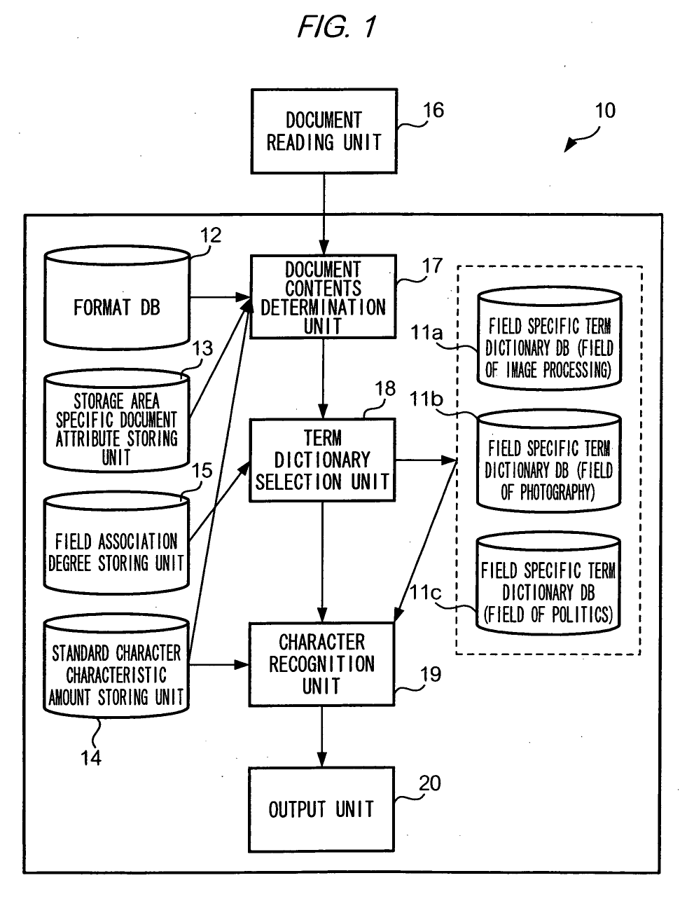

FIG. 1 is a block diagram showing the configuration of a character recognition apparatus 10 according to a first embodiment. This character recognition apparatus 10 may be realized by a computer which is built in a scanner, a hybrid machine, or the like, or may be realized by a computer which serves as a host device connected with a scanner or a hybrid machine. In this first embodiment, plural field specific term dictionary databases containing terms or characters classified into respective fields are prepared to determine which field the contents of a document belong to. Then, a field specific term dictionary database pertaining to the determined field is selected from among the plural field specific term dictionary databases. Character recognition is performed by using the terms or characters stored in the field specific term dictionary database as candidates. For example, FIG. 1 shows field specific term dictionary databases 11a, 11b, and 11c. The field specific term dictionary database 11a contains terms or characters that appear frequently in the field of image processing. The field specific term dictionary database 11b contains terms or characters that appear frequently in the field of photography. The field specific term dictionary database 11c contains terms or characters that appear frequently in the field of politics. Nevertheless, aside from these fields, appropriate field specific term dictionary databases may also be prepared for a variety of fields such as IT, computer, law, personal names, place names, and company names.

A format database 12 contains format information for describing document formats, and the names of fields to which the contents of documents belong, in correspondence with each other. More specifically, the format information includes format identifiers assigned to respective different formats of documents (such as an order form and an application form), and information for describing the characteristics of each format (the form and structure of the format itself). The character recognition apparatus 10 determines which field the contents of a document belong to, based on the contents stored in this format database 12 and the contents of document image data.

A storage area specific document attribute storing unit 13 contains correspondences between storage areas specified as the destinations of storage of document image data when the document image data is generated and respective field names. In currently-prevailing hybrid machines or the like, images read by a scanner can be stored into storage areas corresponding to numbers specified from a menu called “mailbox.” The storage areas capable of being specified from this mailbox are the above-mentioned “storage areas specified as the destinations of storage of document image data when the document image data is generated.” In this mailbox, the specified numbers typically differ, for example, from one organization unit (department, section) to another in a company or from one user to another. Thus, storage areas to which an identical number is assigned often contain document image data of fields similar to each other. For example, in the mailbox to be used by the image processing develop department of a company, the stored documents often pertain to image processing. Thus, the individual storage areas in the mailbox and the fields to be carried by the users or organizations using the storage areas full-time are stored into the storage area specific document attribute storing unit 13 in correspondence with each other. This allows the character recognition apparatus 10 to determine which field the contents of a document belong to, only by referring to the number specified for the mailbox.

A standard character characteristic amount storing unit 14 contains characteristic amounts as to a standard character pattern of each individual character. The character recognition apparatus 10 compares the characteristic amounts stored in this standard character characteristic amount storing unit 14 and the characteristic amounts of a character pattern optically read from a document, and recognizes the character depending on the degree of coincidence therebetween.

By the way, plural fields include ones having higher degrees of association with each other and ones having lower degrees of association. For example, the field of image processing and the field of photography have a high degree of association with each other. The field of image processing and the field of politics, or the field of photography and the field of politics, do not have much association with each other. Information for defining such degrees of association between fields is stored in a field association degree storing unit 15. For example, suppose that a maximum degree of association is expressed as “1.” Then, the information stored in the field association degree storing unit 15 is such that the field of image processing and the field of photography have a degree of association of “0.8,” and the field of image processing and the field of politics, and the field of photography and the field of politics, both have a degree of association of “0.1.”

A document reading unit 16 is an image scanner device, for example. When character recognition processing is started, this document reading unit 16 irradiates the document with light to read the image on the document optically, and generates document image data. A document contents determination unit 17 determines which field the contents of the document shown by the document image data belong to, by using several methods to be described later. A term dictionary selection unit 18 selects the field specific term dictionary databases of fields pertaining to the field determined. Here, the term dictionary selection unit 18 selects not only the field specific term dictionary database of the field determined by the document contents determination unit 17, but also the field specific term dictionary databases of fields that are defined by the field association degree storing unit 15 to have a certain or higher degree of association with that field.

A character recognition unit 19 recognizes characters in the document by referring to the characteristic amounts stored in the standard character characteristic amount storing unit 14, the characteristic amounts of the character pattern optically read from the document, and the field specific term dictionary databases selected. An output unit 20 outputs the result of recognition by using a predetermined method such as screen display.

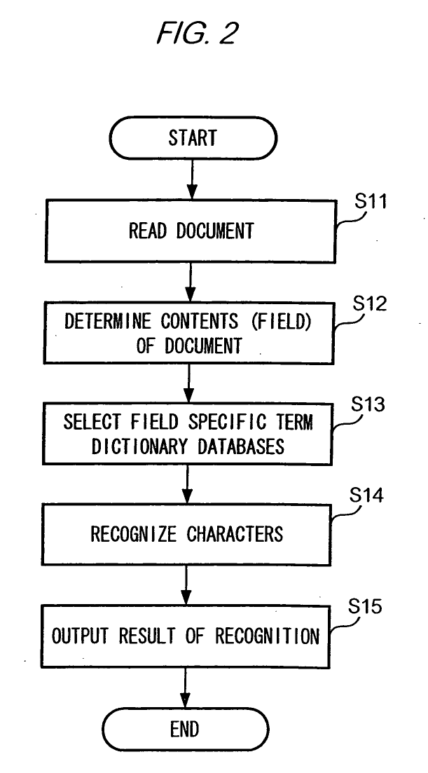

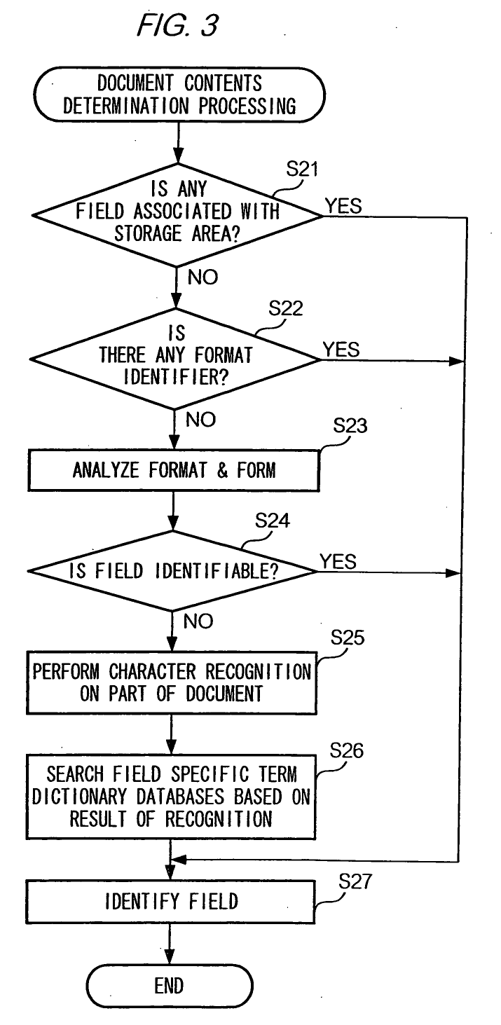

FIGS. 2 and 3 are flowcharts showing the operation of the character recognition apparatus 10.

Initially, in FIG. 2, the document reading unit 16 irradiates the document with light to read the image on the document optically, and generates document image data (step S11). This document image data is supplied from the document reading unit 16 to the document contents determination unit 17. The document contents determination unit 17 determines which field the contents of the document belong to, according to the flowchart shown in FIG. 3 (step S12).

In FIG. 3, the document contents determination unit 17 refers to the contents stored in the storage area specific document attribute storing unit 13, and determines whether any field is associated with the area containing the document image data (step S21). Here, if any field is associated (step S21; Yes), the document contents determination unit 17 identifies the field as the one to which the contents of the document belong (step S27).

On the other hand, if no field is associated (step S21; No), the document contents determination unit 17 determines whether the image shown by the document image data contains any format identifier (step S22). For example, some format identifiers are written in document corners. Here, if any format identifier is detected in the image (step S22; Yes), the document contents determination unit 17 refers to the contents stored in the format database 12 to identify the field corresponding to the format identifier (step S27).

On the other hand, if no format identifier is detected (step S22; No), the document contents determination unit 17 analyzes the format (form and structure) of the document shown by the document image data (step S23). Then, if it is possible to identify the field from the result of analysis and the contents stored in the format database 12 (step S24; Yes), the document contents determination unit 17 identifies the field (step S27).

On the other hand, if it is impossible to identify the field from the format (step S24; No), the document contents determination unit 17 performs character recognition on part of the document shown by the document image data (step S25). By using characters or terms obtained through this recognition processing as search keys, the document contents determination unit 17 searches all the field specific term dictionary data bases 11a, 11b, and 11c (step S26). If any field specific term dictionary database containing matched or similar terms or characters is found in this search, the document contents determination unit 17 identifies the field (step S27).

Here, the character recognition processing at step S25 may be performed by several methods as follows:

Some documents contain both typed characters and handwritten characters. Of these, typed characters are recognized with relatively high degrees of accuracy. Thus, the document contents determination unit 17 determines the field of the document based on the result of character recognition on typed characters. Specifically, the document contents determination unit 17 separates the character area of the document shown by the document image data into a typed character area written in typed characters and a handwritten character area written in handwritten characters. The document contents determination unit 17 then performs character recognition processing on the typed characters written in the typed character area. Then, by using the result of recognition as search keys, the document contents determination unit 17 searches all the field specific term dictionary databases 11a, 11b, and 11c.

Moreover, users may put marks on characteristic contents of a document by using a pen or the like. For example, characteristic contents are sometimes circled, underlined, or checked with a line marker. The document contents determination unit 17 analyzes the document image data and, if there is any marked point, recognizes the characters written on that point by priority. Then, by using the result of recognition as search keys, the document contents determination unit 17 searches all the field specific term dictionary databases 11a, 11b, and 11c. In addition, characters written at the top of a document and characters written in greater font sizes than others often constitute the title or heading of the document, and are therefore often suited to determining which field the contents of the document belong to. Thus, the document contents determination unit 17 analyzes the document image data and, if there are any characters written at the top of the document or written in greater font sizes than others, recognizes those characters by priority. Then, by using the result of recognition as search keys, the document contents determination unit 17 searches all the field specific term dictionary databases 11a, 11b, and 11c.

Returning to FIG. 2, the term dictionary selection unit 18 selects the field specific term dictionary database pertaining to the field determined by the document contents determination unit 17 (step S13). For example, when the contents of the document are determined to belong to the field of image processing, the term dictionary selection unit 18 selects the field specific term dictionary database 11a which is on the field of image processing. Besides, the term dictionary selection unit 18 refers to the contents stored in the field association degree storing unit 15, and also selects the field specific term dictionary database 11b which is on the field that is defined to have a certain or higher degree of association with the field of image processing mentioned above (here, the field of photography).

Next, the character recognition unit 19 recognizes the characters or terms in the document by referring to the characteristic amounts stored in the standard character characteristic amount storing unit 14, the characteristic amounts of the character pattern optically read from the document, and the contents of the field specific term dictionary databases 11a and 11b selected (step S14). The output unit 20 outputs the result of recognition by using a predetermined method such as screen display (step S15).

According to the first embodiment described above, field specific term dictionary databases containing characters or terms appropriate are selected in view of the contents of the document. An improvement is thus expected of the recognition accuracy.

### (2) Second Embodiment

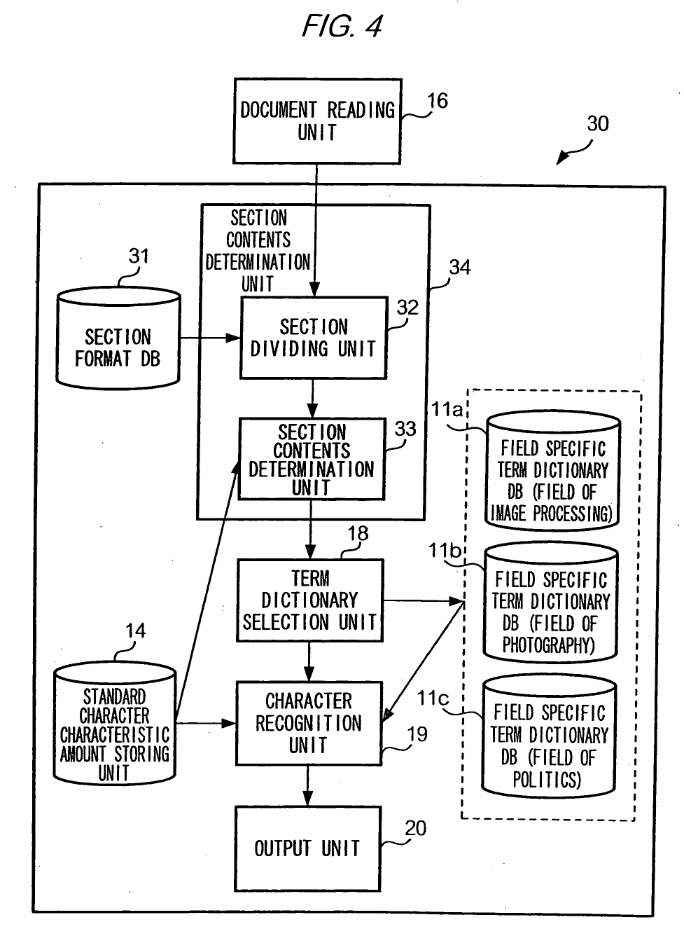

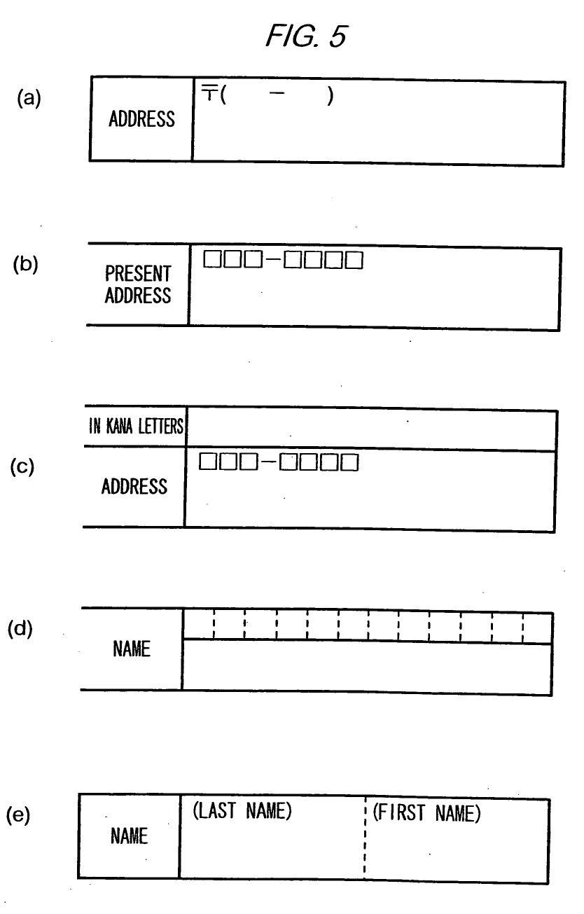

In the foregoing first embodiment, character recognition is performed on an entire document by using field specific term dictionary databases selected. In the second embodiment to be described below, a single document is divided into plural areas. Then, field specific term dictionary databases appropriate for the respective areas are selected for character recognition. FIG. 4 is a block diagram showing the configuration of a character recognition apparatus 30 according to the second embodiment. The same components as in FIG. 1 will be designated by like reference numerals. The character recognition apparatus shown in FIG. 4 differs from the character recognition apparatus of the first embodiment shown in FIG. 1 in that a section format database 31 and a document contents determination unit 34 (a section dividing unit 32 and a section contents determination unit 33) are provided instead of the format database 12, the storage area specific document attribute storing unit 13, the field association degree storing unit 15, and the document contents determination unit 17. The section format database 31 contains information for describing the forms and sizes of sections to be filled out in documents. For example, this information includes the forms and sizes of various sections such as conceptually shown in FIGS. 5A to 5E.

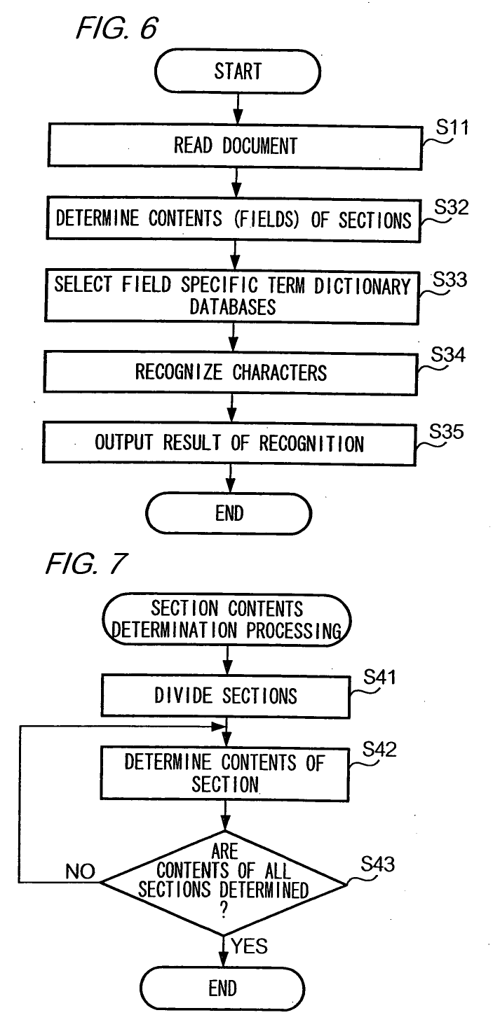

FIGS. 6 and 7 are flowcharts showing the operation of the character recognition apparatus 30.

The operation shown in FIG. 6 differs from the foregoing operation shown in FIG. 2 in that the processing of steps S32 to S35 to be performed section by section is included instead of the processing of steps S12 to S15 which is performed on an entire document. That is, the document reading unit 16 irradiates the document with light to read the image on the document optically, and generates document image data (step S11). Then, the document contents determination unit 34 determines the contents (field) section by section (step S32). Specifically, as shown in FIG. 7, the section dividing unit 32 initially refers to the contents stored in the section format database 31, and divides the document in units of sections to be filled out (step S41). Next, the section contents determination unit 33 analyzes the form and size of a section, and any typed characters, symbols, and marks written in the section (for example, typed characters such as “Name” and “Address,” and symbols which represents zip code or telephone number). Based on the result of analysis, the section contents determination unit 33 identifies the field of the contents written in the section (step S42). For example, the contents of a section having the description of “Address” shall belong to the field of place names. The contents of a section having the description of “Name” shall belong to the field of personal names. Such processing is performed on all the sections (step S43; Yes) before the processing shown in FIG. 7 is completed.

Returning to FIG. 6, the term dictionary selection unit 18 selects the field specific term dictionary databases pertaining to the fields determined by the document contents determination unit 34 section by section (step S33). The character recognition unit 19 recognizes the characters or terms in the sections by referring to the characteristic amounts stored in the standard character characteristic amount storing unit 14, the characteristic amounts of the character pattern optically read from the document, and the contents of the field specific term dictionary databases selected section by section (step S34). The output unit 20 outputs the result of recognition by using a predetermined method such as screen display (step S35).

According to the second embodiment described above, a document is divided in units of sections to be filled out, and appropriate field specific term dictionary databases are selected according to the contents of the respective sections. It is therefore possible to perform character recognition with a higher degree of accuracy than in the first embodiment.

(3) Modifications

The present invention may be practiced by the following modifications of the foregoing embodiments.

The fields and the field specific term dictionary databases are not limited to those illustrated in the embodiments, and may be set freely in accordance with the types and contents of documents for which the character recognition processing is targeted.

The first embodiment and the second embodiment may also be practiced in combination. For example, in the second embodiment, character recognition may be performed with consideration given to the degrees of association between fields as in the first embodiment.

When the character area in a document is divided into plural subareas, it may be divided in units of chapters, sections, or paragraphs in the document, not in units of sections to be filled out.

Control programs for the character recognition apparatuses 10 and 30 to perform the foregoing operations may be provided to the character recognition apparatuses 10 and 30 in a recorded form on such a recording medium as a magnetic recording medium, an optical recording medium, and a ROM which are readable to a CPU or other processors. The control programs may also be downloaded to the character recognition apparatuses 10 and 30 over a network such as the Internet.

As described above, some embodiments of the invention are outlined below.

The embodiments of the present invention provides a character recognition apparatus including: plural dictionary databases that contain terms or characters classified into respective fields; a determination unit that determines which field the contents of a document shown by document image data belong to; a selection unit that selects a dictionary database pertaining to the field determined by the determination unit from among the plural dictionary database; a recognition unit that recognizes a term or a character written in the document shown by the document image data by using the terms or characters stored in the selected dictionary database as candidates; and an output unit that outputs the result of recognition by the recognition unit. According to this character recognition apparatus, the field to which the contents of a document belong is determined before a field specific term dictionary database appropriate for that field is selected and used for character recognition. An improvement is thus expected of the recognition accuracy.

In the embodiment of this invention, the character recognition apparatus further includes an area division unit that divides a character-written area of the document into plural subareas. The determination unit determines which fields the contents written in the divided subareas belong to subarea by the subarea. The selection unit selects the dictionary database pertaining to the respective fields determined by the determination unit. The recognition unit recognizes a term or a character written in the areas by using the terms or characters stored in the selected dictionary database as candidates. According to this aspect, field specific term dictionary databases appropriate for respective subareas of a document can be selected and used for character recognition.

In the embodiment of this invention, the determination unit separates a character area of the document shown by the document image data into a typed character area written in typed characters and a handwritten character area written in handwritten characters, performs character recognition on typed characters written in the typed character area, and compares the result of recognition with the terms or characters stored in each of the plural dictionary databases to determine which field the contents written in the document shown by the document image data pertain to. Some documents contain both typed characters and handwritten characters. Of these, typed characters are recognized with relatively high degrees of accuracy. Thus, appropriate field determination can be performed by determining the field of the document based on the result of character recognition on the typed characters.

In the embodiment of this invention, the character recognition apparatus further includes an attribute memory that contains a correspondence between a storage area specified as the destination of storage of the document image data when the data is generated and the respective dictionary database. Based on the correspondence stored in the attribute memory, the determination unit selects the dictionary database corresponding to the storage area containing the document image data. In currently-prevailing hybrid machines or the like, images read by a scanner can be stored into storage areas corresponding to numbers specified from a menu called “mailbox.” In this mailbox, the numbers specified typically differ, for example, from one organization unit (department, section) to another in a company or from one user to another. Consequently, storage areas to which an identical number is assigned often contain document image data of fields similar to each other. Thus, the storage areas specified as the destinations of storage of document image data when the data is generated (for example, the individual storage areas in the mailbox) and the field specific dictionary storing units (for example, the fields to be carried by the users or organizations using those storage areas full-time) are stored in correspondence with each other. This makes it possible to determine which field the contents of a document belong to simply by specifying a storage area.

In the embodiment of this invention, the character recognition apparatus further includes an association degree memory that stores an association degree which defines the degrees of association between the fields. The selection unit selects the dictionary database of a field defined by the association degree to have a certain degree of association with the field determined by the determination unit.

The embodiments of the present invention provides a character recognition method including: storing terms or characters by field in plural dictionary databases; determining which field contents of a document shown by document image data belong to; selecting a dictionary database pertaining to the determined field determined from among the plurality of dictionary database; recognizing a term or a character written in the document shown by the document image data by using the terms or characters stored in the selected dictionary database as candidates; and outputting a result of the recognition.

In the embodiment of the invention, the character recognition method further includes dividing a character-written area of the document into plural subareas. The determining step includes determining which fields the contents written in the divided subareas belong to subarea by the subarea. The selecting step includes selecting a dictionary database pertaining to the respective determined fields. The recognizing step includes recognizing a term or a character written in the areas by using the terms or characters stored in the selected dictionary database as candidates.

In the embodiment of the invention, the determining step includes: separating a character area of the document shown by the document image data into a typed character area written in typed characters and a handwritten character area written in handwritten characters; performing character recognition on typed characters written in the typed character area; and comparing a result of the recognition with the terms or characters stored in each of the plurality of the dictionary databases to determine which field the contents written in the document shown by the document image data pertain to.

In the embodiment of the invention, the character recognition method further includes storing in an attribute memory, a correspondence between a storage area specified as the destination of storage of the document image data when the data is generated and the respective dictionary database. The determining step includes selecting, based on the correspondence stored in the attribute memory, a dictionary database corresponding to the storage area containing the document image data.

In the embodiment of the invention, the character recognition method further includes storing in an association degree memory, an association degree which defines degrees of association between the fields. The selecting step includes selecting a dictionary database of a field defined by the association degree to have a certain degree of association with the determined field.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical application, to thereby enable others skilled in the art to understand other embodiments or modifications which can be applied to the particular use contemplated. It is intended that the scope of the invention be defined by the following claims and their equivalents.

What is claimed is:

1. A character recognition apparatus comprising:
a plurality of dictionary databases that contain terms or characters classified into respective fields;
a determination unit that determines which field contents of a document shown by document image data belong to;
a selection unit that selects a dictionary database pertaining to the field determined by the determination unit from among the plurality of dictionary databases;
a recognition unit that recognizes a term or a character written in the document shown by the document image data by using the terms or characters stored in the selected dictionary database as candidates; and
an output unit that outputs the result of recognition by the recognition unit.

2. The character recognition apparatus according to claim 1, further comprising an area division unit that divides a character-written area of the document into a plurality of subareas, and wherein:
the determination unit determines which fields the contents written in the divided subareas belong to subarea by the subarea;
the selection unit selects the dictionary database pertaining to the respective fields determined by the determination unit; and
the recognition unit recognizes a term or a character written in the areas by using the terms or characters stored in the selected dictionary database as candidates.

3. The character recognition apparatus according to claim 1, wherein
the determination unit separates a character area of the document shown by the document image data into a typed character area written in typed characters and a handwritten character area written in handwritten characters, performs character recognition on typed characters written in the typed character area, and compares the result of recognition with the terms or characters stored in each of the plurality of the dictionary databases to determine which field the contents written in the document shown by the document image data pertain to.

4. The character recognition apparatus according to claim 1, further comprising an attribute memory that contains a correspondence between a storage area specified as the destination of storage of the document image data when the data is generated and the respective dictionary database, and wherein
based on the correspondence stored in the attribute memory, the determination unit selects the dictionary database corresponding to the storage area containing the document image data.

5. The character recognition apparatus according to claim 1, further comprising an association degree memory that stores an association degree which defines degrees of association between the fields; and wherein
the selection unit selects the dictionary database of a field defined by the association degree to have a certain degree of association with the field determined by the determination unit.

6. A character recognition method comprising:
storing terms or characters by field in a plurality of dictionary databases;
determining which field contents of a document shown by document image data belong to;
selecting a dictionary database pertaining to the determined field determined from among the plurality of dictionary database;
recognizing a term or a character written in the document shown by the document image data by using the terms or characters stored in the selected dictionary database as candidates; and
outputting a result of the recognition.

7. The character recognition method according to claim 6, further comprising dividing a character-written area of the document into a plurality of subareas, and wherein:
the determining step includes determining which fields the contents written in the divided subareas belong to subarea by the subarea;
the selecting step includes selecting a dictionary database pertaining to the respective determined fields; and
the recognizing step includes recognizing a term or a character written in the areas by using the terms or characters stored in the selected dictionary database as candidates.

8. The character recognition method according to claim 6, wherein
the determining step includes:
separating a character area of the document shown by the document image data into a typed character area written in typed characters and a handwritten character area written in handwritten characters;
performing character recognition on typed characters written in the typed character area; and
comparing a result of the recognition with the terms or characters stored in each of the plurality of the dictionary databases to determine which field the contents written in the document shown by the document image data pertain to.

9. The character recognition method according to claim 6, further comprising storing in an attribute memory, a correspondence between a storage area specified as the destination of storage of the document image data when the data is generated and the respective dictionary database, and wherein
the determining step includes selecting, based on the correspondence stored in the attribute memory, a dictionary database corresponding to the storage area containing the document image data.

10. The character recognition method according to claim 6, further comprising storing in an association degree memory, an association degree which defines degrees of association between the fields; and wherein
the selecting step includes selecting a dictionary database of a field defined by the association degree to have a certain degree of association with the determined field.
